(19) United States
(12) Patent Application Publication
(10) Pub. No.: US 2003/0009466 A1
(43) Pub. Date: Jan. 9, 2003

(54) Search engine with pipeline structure

(76) Inventors: John D. C. Ta, Laguna Niguel, CA (US); James Ching-Shau Yik, Mission Viejo, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/886,599

(22) Filed: Jun. 21, 2001

(51) Int. Cl. G06F 7/00

(52) U.S. Cl. 707/100

(57) ABSTRACT

A pipeline search engine. A plurality of logically partitioned pipeline structures are provided for inputting packet information of a packet with a first pipeline of the plurality of pipeline structures to generate pointing information therefrom. The pointing information is processed with a second pipeline structure of said plurality of pipeline structures to obtain destination information of one or more destination outputs. The destination information is forwarded to an output pipeline structure of the plurality of pipeline structures for transmission of the packet to the one or more destination outputs.

### BACKGROUND OF THE INVENTION

1. Technical Field of the Invention

This invention is related to network switching devices, and more particularly, the search engines utilized therein.

2. Background of the Art

The performance of a network switching device is dependent, in part, upon the design of the address table created to map ports, and the search engine utilized for searching and retrieving port address information from the table. However, such conventional architectures impart delay into the flow of frames from a source device to a destination device.

What is needed is an architecture which operates with address table look-up such that frames can be forwarded to the appropriate destination device at or near the wire speed.

### SUMMARY OF THE INVENTION

The present invention disclosed and claimed herein, in one aspect thereof, comprises a pipeline search engine. A plurality of logically partitioned pipeline structures are provided for inputting packet information of a packet with a first pipeline of the plurality of pipeline structures to generate pointing information therefrom. The pointing information is processed with a second pipeline structure of said plurality of pipeline structures to obtain destination information of one or more destination outputs. The destination information is forwarded to an output pipeline structure of the plurality of pipeline structures for transmission of the packet to the one or more destination outputs.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a general block diagram of the pipeline search engine, in accordance with a disclosed embodiment;

FIG. 2a illustrates a prior art Ethernet frame with accompanying interframe gap;

FIG. 2b illustrates a prior art tagged Ethernet packet which is compatible with the disclosed architecture;

FIG. 3 illustrates a flow diagram of packet information processing in accordance with the disclosed pipeline architecture;

FIG. 4 illustrates a flow chart of a portion of the frame processing of the system of FIG. 1;

FIG. 5 illustrates a flow chart of one task by the Control State Machine, in accordance with a disclosed embodiment;

FIG. 6 illustrates a flow chart of a second task, in accordance with a disclosed embodiment;

FIG. 7 illustrates a diagram of a data structure for an external MAC address;

FIG. 8 illustrates a diagram of a data structure for an external IP Multicast address; and

FIG. 9 illustrates a diagram of a generic data format of an Ethernet packet with VLAN ID and VLAN Tag information.

### DETAILED DESCRIPTION OF THE INVENTION

The disclosed novel architecture is an implementation of a pipeline search engine structure in a switching device which supports eight Gigabit-Ethernet ports at the full switching line rate. In general, the search engine is logically partitioned into three pipeline tasks. Each task takes less than eleven clock cycles in which to be completed. Thus with a 3-stage pipelined architecture, generally, the net result takes less than eleven clock cycles to complete. However, if the infrequent event of learning is necessary, the task can take more than eleven cycles. The 8-port Gigabit-Ethernet switch provides switching functions to forward frames from the input ports to the output ports of the switching device at the full line rate (or wire speed). The search engine can accommodate Ethernet frame sizes varying from 64 bytes to 1.5 kilobytes (KB), is arranged in a pipeline structure, and is operable to sustain the output line rate, in a worst case, where all eight input ports simultaneously transmit bursty traffic of 64-byte packet information. The data path of the search engine is arranged in a pipeline structure so that bursty packet information can be processed and forwarded among the eight ports at the output wire speed.

The primary function of the search engine is to find the destination port to which the packet is to be forwarded, and forward the packet to its appropriate destination port of the destination device in a predetermined amount of time, otherwise there will be an idle time gap (i.e., interframe gap (IFG)) between outgoing packets. For eight Gigabit-Ethernet ports in a full duplex switch, the average available time that the search engine must forward the 64-byte packet information (worst case scenario) from each port is 84 ns (i.e., 672 ns/8 ports).

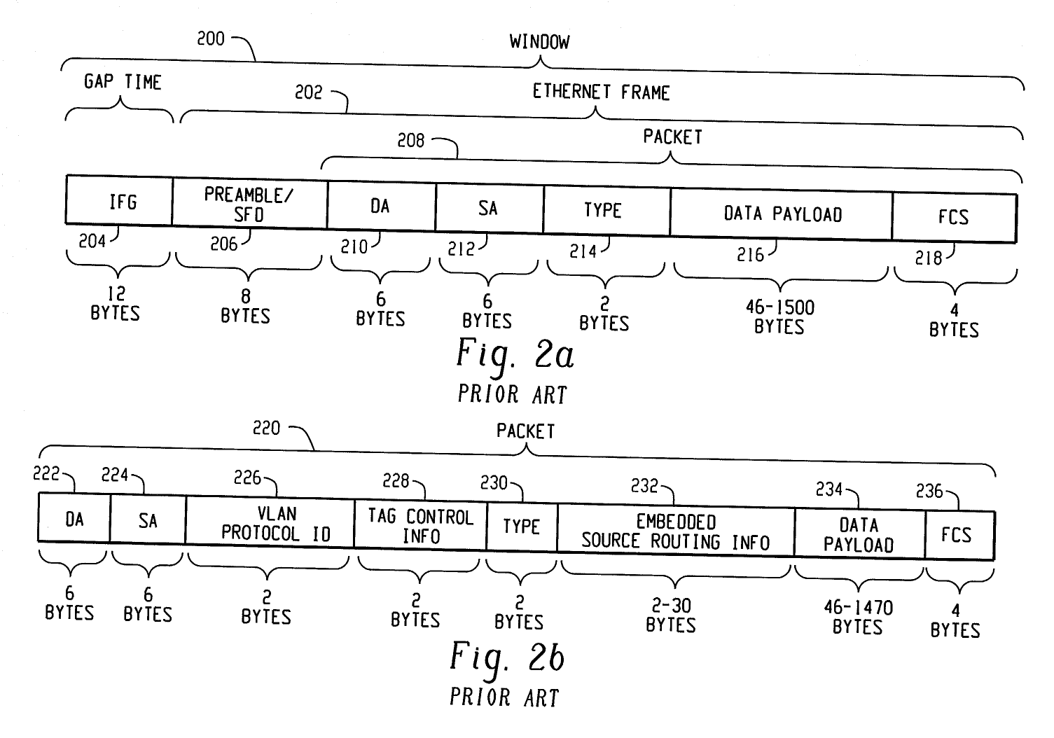

Referring now to FIG. 2a, there is illustrated a prior art Ethernet frame with accompanying. The aggregate bandwidth of the switch is based upon an 84-byte window 200 comprising a standard Ethernet frame 202 (denoted by an accompanying bracket in the FIG. 2) and accompanying IFG 204. More specifically, the window 200 comprises twelve bytes of IFG 204, eight bytes of preamble/start-of-frame delimiter (SFD) 206, and a 64-byte packet 208 denoted in accordance with a bracketed portion of FIG. 2. The 64-byte packet 208 comprises six bytes of Destination Address (DA) 210, six bytes of Source Address (SA) 212, two bytes of Type information 214, a data payload 216 of 46 bytes (of a maximum of 1500 bytes), and four bytes of frame check sequence (FCS) 218. The 84-byte window 200 approximates 672 ns, in a system with Gigabit-Ethernet operating at 1 GHz, such that (12 bytes of IFG+8 bytes of Preamble+64 bytes of data)×(8 bits/byte)×(1 ns/bit)=672 ns. With this time budget, the search engine has to complete the search-and-forward operation of the packet 208 within a predetermined number of clock cycles. Utilizing a 133 MHz system clock, the whole search-and-forward process has to take place in less than eleven system clock cycles (84 ns/7.5 ns). Since each task of the novel architecture can be performed in less than eleven clock cycles, the packets can be forwarded within the required time limit.

Referring now to FIG. 2b, there is illustrated a prior art tagged Ethernet packet 220 which can be accommodated by the disclosed architecture. Virtual LAN (VLAN) technology provides for the separation of logical connectivity from physical connectivity, i.e., users are still connected via physical cables, but the station or application now views the connectivity as no longer restricted to the bounds of the physical topology. The LAN is virtual in that a set of stations and applications can now behave as if connected to a single physical LAN when in fact they are not. The tagged VLAN packet 220 is a subset of a tagged Ethernet frame (not shown). The VLAN packet 220, in this particular embodiment, comprises six bytes of Destination Address (DA) 222 (similar to DA 210), six bytes of Source Address (SA) 224 (similar to SA 212), two bytes of VLAN ID 226, two bytes of tag control information 228, two bytes of Type information 230 (similar to Type 214), embedded source routing information 232, a data payload 234 of 40 bytes (of a maximum of 1470 bytes, and similar to data payload 216), and four bytes of FCS 236 (similar to FCS 218). (Note that the VLAN Ethernet packet 220 may also be an “untagged”VLAN packet which excludes the embedded source routing information 232, and which is also compatible with the disclosed architecture.) As mentioned hereinabove, if the frame is a VLAN-type frame, then four bytes of VLAN information are located right after the SA 224 (i.e., VLAN Tag (two bytes)+VLAN ID (two bytes)). The VLAN Tag is a special code which is read during the parsing process, such that the search engine can identify whether or not the packet is a VLAN packet. In general, the 64-byte packet information is of sufficient length to carry VLAN-type information. As before, the 84-byte window approximates 672 ns, in a system with a Gigabit-Ethernet port operating at 1 GHz, such that (12 bytes of IFG+8 bytes of Preamble+64 bytes of data)×(8 bits/byte)×(1 ns/bit)=672 ns. As indicated hereinabove, with this time budget, the search engine has to complete the search-and-forward operation of the VLAN header information of the VLAN packet 220 in less than eleven clock cycles in order to maintain throughput at or near wire speed. Since each task of the novel architecture can be performed in less than eleven clock cycles, the packets associated with the corresponding packet information can be forwarded within the required time limit.

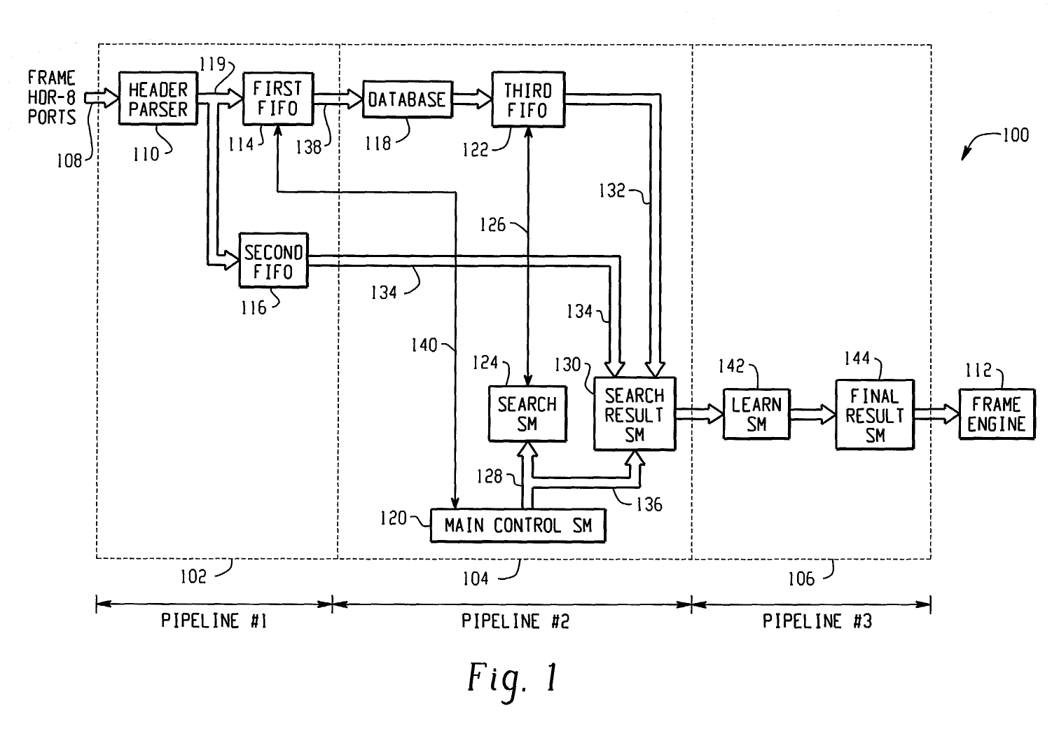

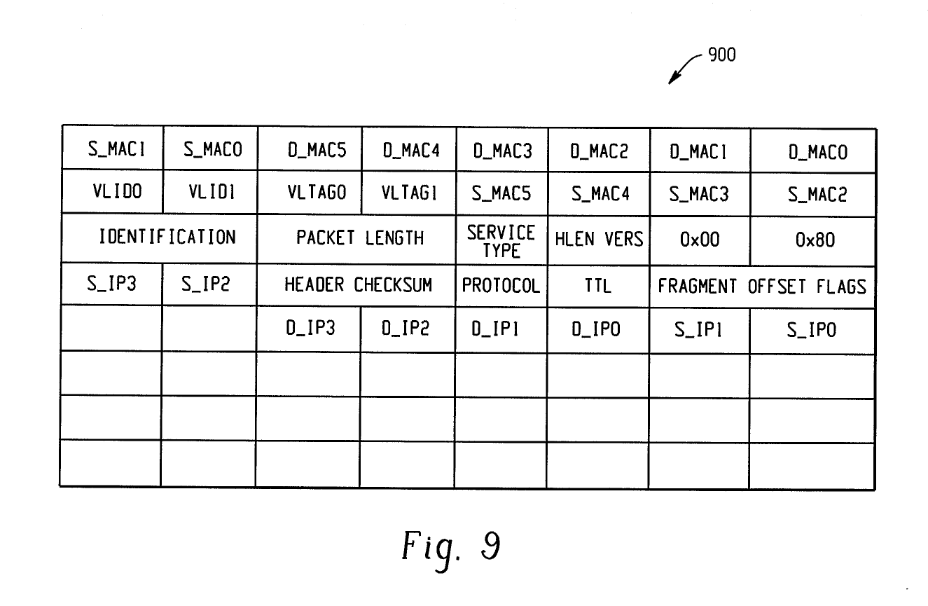

Referring now to FIG. 1, there is illustrated a general block diagram of the pipeline search engine 100, in accordance with a disclosed embodiment. In general, the search engine 100 is logically partitioned into three pipelined sections (102, 104, and 106). Each pipeline section (102, 104, and 106) takes substantially less than eleven clock cycles to perform its respective operations, when no learning is required. Thus packet information of a packet can be forwarded through the entire pipeline search engine 100 within the required time limit of eleven clock cycles. The first 64-byte header information of each received frame 202 (and also a VLAN frame containing the VLAN packet 220) of an incoming bus 108 of eight Gigabit-Ethernet ports is passed to a header parser 110 for parsing, processing, and classifying of the types of frames 202. (Note that the packet header information is made available to the pipeline search engine 100 only if the corresponding received packet is error-free and determined to be a valid packet.) During processing of a tagged VLAN frame various bits of information are extracted from the 64-byte header, including the SA 224, DA 222, VLAN Tag 228, VLAN ID 226, Protocol type 230, Source IP address, and Destination IP address. A more detailed description of the header components are described hereinbelow with respect to FIG. 9. (Note that the Destination and Source IP addresses are embedded deep into the Embedded Source Routing Info 232.) Frame classification means to determine inter alia packet transmit Priority, Discard Priority, Unicast/Multicast, IP Multicast, whether tagged or untagged, and the VLAN ID. If the packet is a Multicast packet, many different destination ports will receive the packet.

The search engine 100 controls the destination ports by marking each destination port bit map (i.e., nine bits which comprise eight Ethernet ports and one CPU port, where each bit represents a port) and forwards these bits via an interface to a Frame Engine block 112 at the output of the pipeline search engine 100. The Frame Engine 112 is responsible for sending the packet payload to the appropriate destination ports.

The first (or input) pipeline 102 comprises the header parser logic 110 for processing header information of each of the incoming eight Gigabit-Ethernet ports of the bus 108 and, a first FIFO (First In-First Out) 114 and a second FIFO 116 for receiving information from the header parser block 110. However, prior to insertion of information from the header parser 110 via a bus 119 into the first FIFO 114, information of the tagged Ethernet packet header such as the destination MAC address 222 and the source MAC address 224, Source IP address and Destination IP address both of which are embedded in the Source Routing information 232, and VLAN ID 226 are hashed to yield a database entry pointer compatible with a database 118. The pointer is a 16-bit address index of the database 118. The database entry pointer and other packet-related information are arranged into a format called packed-header-packet (PHP) information, and piped into the first FIFO 114 (having a buffer capacity of sixteen entries) before routing to a Control SM (State Machine) 120 of the second (or intermediate) pipeline 104 for processing. (The PHP is forty-four bits wide, where bit[43:32]=VLAN_ID[11:0], bit[31:16]=the 16-bit Source MAC address hash-result pointer, and bit[15:0]=16-bit Destination MAC or IP address hash-result pointer.)

The second pipeline 104 comprises a number of operational blocks: the database 118; a third FIFO 122 which receives the output of the database 118; a Search SM 124 which communicates with the third FIFO 122 over a link 126 and receives information from the Control SM 120 over a bus 128; a Search Result SM 130 which receives the output of the third FIFO 122 via a bus 132, the output of the second FIFO 116 over a bus 134, and information from the Control SM 120 via the bus 136. The second pipeline 104 also contains the Control SM 120 which monitors and controls all functions of the pipeline architecture 100.

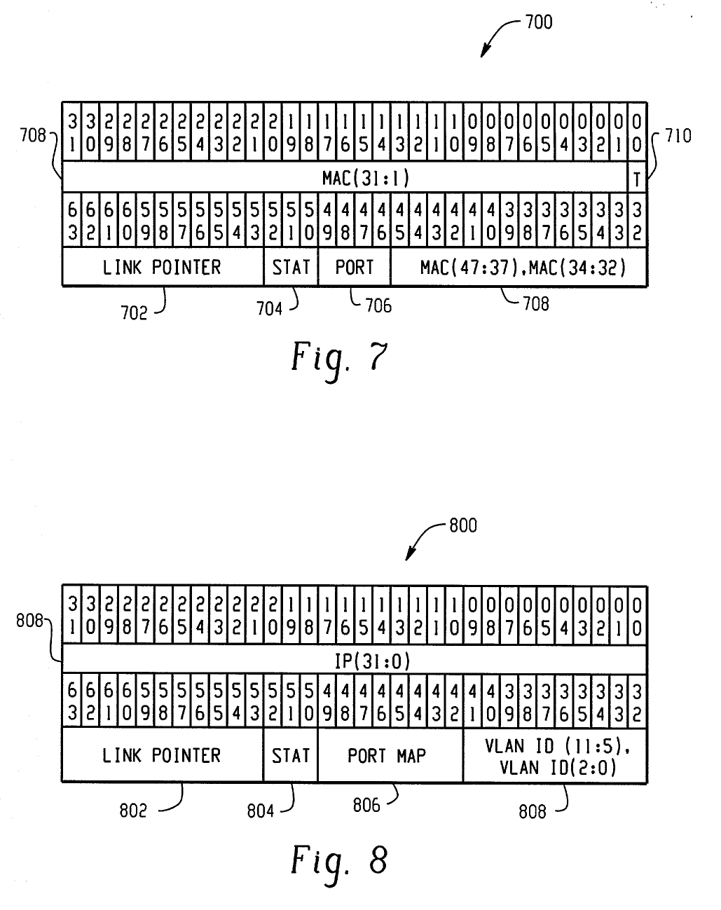

When the output of the first FIFO 114 is available, the Control SM 120 monitors the availability of the output of the first FIFO 114, and initiates the Search SM 124 via the bus 128. Duplicate packet header information such as DA 222, SA 224, VLAN ID 226, and Destination IP address of the Source Routing information 232 are arranged into a format called header-packet (HP) information. The HP information is loaded into the second FIFO 116 of the first pipeline 102 via the bus 119, and the Search Result SM 130 obtains the HP information from the second FIFO 116 via the information bus 134 to perform a comparison with the results from the third FIFO 122 of the second pipeline section 104 to determine if the database entry matches the DA 222. If there is a match, the packet is forwarded in accordance with the destination address. If there is not a match, the learning process is required which causes the database 118 to be updated with a new destination address associated with database pointer generated by the packet header information. A more detailed description of the database 118 is provided hereinbelow with respect to FIG. 7 and FIG. 8.

The Control SM 120 processes two parallel tasks, each task independent from the other and each task run across separate buses to maximize switch throughput. The Control SM 120 controls an output bus 138 of the first FIFO 114, the Search SM bus 128, Search Result SM bus 136, and third FIFO bus 132 to maximize the throughput of the search pipeline 100. The first task is performed by the Control SM 120. The Control SM 120 monitors the output of the first FIFO 114 via a link 140, which output data is the PHP information. When the PHP information is available at the output of the FIFO 114, the Control SM 120 initiates the Search SM 124. The PHP information contains a database address pointer which is used to locate and retrieve corresponding entry information from the database 118. The database entry contains the MAC/IP addresses and a corresponding Destination Port ID. The resulting information of the search is forwarded from the database 118 into the third 16-entry FIFO 122.

The second task is performed by four independent state machines: the Search SM 124, the Search_Result SM 130, a Learn SM 142, and a Final_Result SM 144. The third (or output) pipeline 106 comprises the Learn SM 142 and Final_Result SM 144. While the new entry search result is being continuously piped into the third FIFO 122, the output of the third FIFO 122 is being constantly evaluated by the Search SM 124 via the link 126. When the output of the third FIFO 122 is ready, the Search Result SM 130 examines the result. In the Search Result SM 130, the MAC/IP field of the database entry is checked by comparing the stored database address with the packet's Destination MAC/IP addresses. If the destination MAC/IP address is matched, learning is not required, and the destination port is extracted from the entry and forwarded through the Learn SM 142 to the Final Result SM 144, which is the output path to the Frame Engine 112. If learning is required, the Learn SM 142 is activated to perform the learning function, otherwise, information is passed through the Learn SM 142 to the Final Result SM 144, and eventually, to the Frame Engine 112. As mentioned hereinabove, the learning process takes longer than eleven system clock cycles to complete.

During the Final Result SM 144 stage, the destination port information is trunked or regrouped into the final destination ports. Trunking offers a mechanism for providing greater throughput utilizing the higher bandwidth obtained by logically grouping multiple ports to feed a destination. For example, to get double the bandwidth for a certain logical connection, trunking can be used to logically groups two ports, e.g. port #1 and port #2 in order to get double bandwidth (e.g., 2 Gbps). Trunking also attempts to distribute frame traffic evenly among the ports within a trunk. For example, where a Unicast packet is destined to a trunk port, it can be forwarded to any port within its trunk without making any logical difference. A Multicast packet, instead of being forwarded to both ports #1 and #2, is forwarded to one port, which should be sufficient. The final information of the destination ports is then forwarded to the Frame Engine for distribution to the appropriate ports.

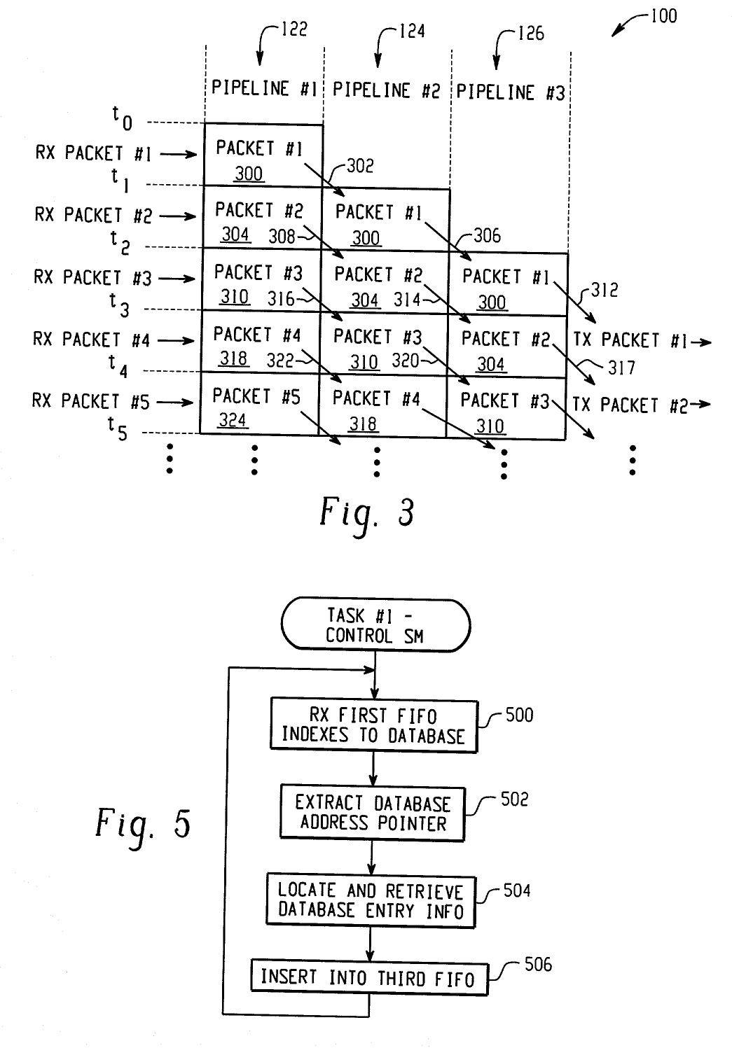

Referring now to FIG. 3, there is illustrated a transitional block diagram of packet information processing in the disclosed pipelined structure. Note that the following discussion begins from a power-up state where no bursty packet information has been received into the disclosed pipeline architecture 100. At a time t₀, a first information packet 300 enters the first pipeline section 102 for processing. At a time t₁, the first pipeline section 102 of the pipeline architecture 100 has completed processing of the first information packet 300, and passes the first processed information packet 300 to the second pipeline section 104, as designated with an arrow 302, and receives a second information packet 304 in the first pipeline section 102. From time t₁ to a time t₂, both pipeline sections 102 and 104 process respective bursty information packets 304 and 300. At the time t₂, processing is complete in both pipeline sections 102 and 104 on the respective information packets 304 and 300, and the information packets 300 and 304 are passed to subsequent pipeline sections, i.e., the first information packet 300 is passed to the third pipeline section 106 (denoted by an arrow 306), and the second information packet 304 is passed to the second pipeline section 104 (denoted by an arrow 308). A third information packet 310 is then received into the first pipeline section 102 of the pipeline architecture 100 for processing. At a time t₃, substantially all pipeline processing is again completed such that the first information packet 300 has now completed processing in the pipeline architecture 100, and is transmitted out of the pipeline architecture 100 to the Frame Engine 112, and therefrom to the appropriate destination device (as denoted by an arrow 312). Further, at time t₃, the second information packet 304 has completed processing in the second pipeline section 104, and is passed to the third pipeline structure 106 (denoted by an arrow 314). The third information packet 310 has completed processing in the first pipeline section 102 and is passed to the second pipeline section 104 (as denoted by an arrow 316). Additionally, a fourth information packet 318 enters the pipeline architecture 100 into the first pipeline section 102 at this time t₃. The process continues in subsequent time slots such that at a time t₄, the second information packet 304 is transmitted from the third pipeline section 106 of the pipeline architecture 100 to the appropriate destination device (denoted by an arrow 317), and pipelined information packets 310 and 318 are passed to subsequent pipeline sections 106 and 104, respectively (denoted with corresponding arrows 320 and 322), while a fifth bursty information packet 324 is received into the pipeline architecture 100. As indicated hereinabove, the worst case scenario is when the information packet sizes are 64 bytes in length, requiring the highest processing bandwidth to preclude any IFG times. When learning is not required, a 64-byte information packet is processed through all three pipeline sections (102, 104, and 106) within eleven clock cycles. Note that it can be appreciated that the structure of, for example, the first information packet 300 is altered as it passes through the pipeline architecture 100, and is not the same structure at the output of the pipeline 100. The illustration in FIG. 3 is intended to convey that when the pipeline search engine 100 is “full” of information packets, that is, each logical pipeline (102, 104, and 106) is processing a separate piece of packet information, each of the pipeline structures (102, 104, and 106) processes the bursty information packets independently of the other two pipeline structures, i.e., in a parallel fashion, in accordance with what is commonly understood as a pipeline operation.

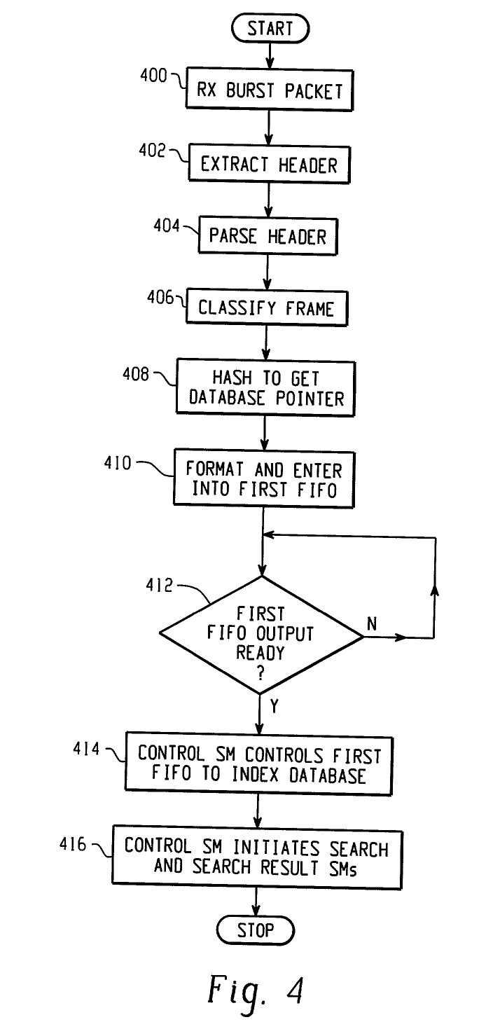

Referring now to FIG. 4, there is illustrated a flow chart of a portion of the frame processing of the system of FIG. 1. Flow begins at a Start block and continues to a function block 400 where the system 100 receives a bursty information packet 208 into the header parser 110. The header parser 110 then extracts portions of the packet header, as indicated in a function block 402. The header parser 110 then processes the packet information and classifies the packet according to type, as indicated in a function block 406. Flow is then to a function block 408 where the header parser 110 then hashes information of the packet header such as the source MAC and destination MAC or IP addresses to yield the database entry pointer. Flow is to a function block 410 where the database entry pointer is combined with other packet-related information, and arranged into a format compatible with the first FIFO 114. The formatted information is the packed-header-packet information, which is then piped into the first FIFO 114.

Flow is next to a decision block 412 to determine when the PHP entry in the first FIFO 114 is at the first FIFO 114 output port. If the PHP entry is not at the output, flow is out the “N” path, and loops back to the input of decision block 412 to continue checking the availability of the PHP entry at the first FIFO 114 output port. When the PHP entry becomes available at the output of the first FIFO 114, flow is out the “Y” path to a function block 414, where the Control SM 120 controls the output of the first FIFO 114 to index the database 118. At this point, flow is to a function block 416, where the Control SM 120 operates to initiate the Search SM 124 and the Search Result SM 130.

Referring now to FIG. 5, there is illustrated a flow chart of one task by the Control SM 120, in accordance with a disclosed embodiment. Flow begins at a starting point, and flows to a function block 500 where the output PHP is indexed to the database 118. As mentioned hereinabove, the PHP information contains the database address pointer which is used to locate and retrieve the entry information for the database 118, provided the MAC/IP address are already in the database 118. The database entry information contains the MAC/IP address and its corresponding Destination Port ID. Flow continues to a function block 506 where the resulting search information is then forwarded and piped into the third FIFO 122, another 16-entry FIFO. Flow continues from the function block 506 and loops back to the input of function block 500 to process then next output from the first FIFO 114.

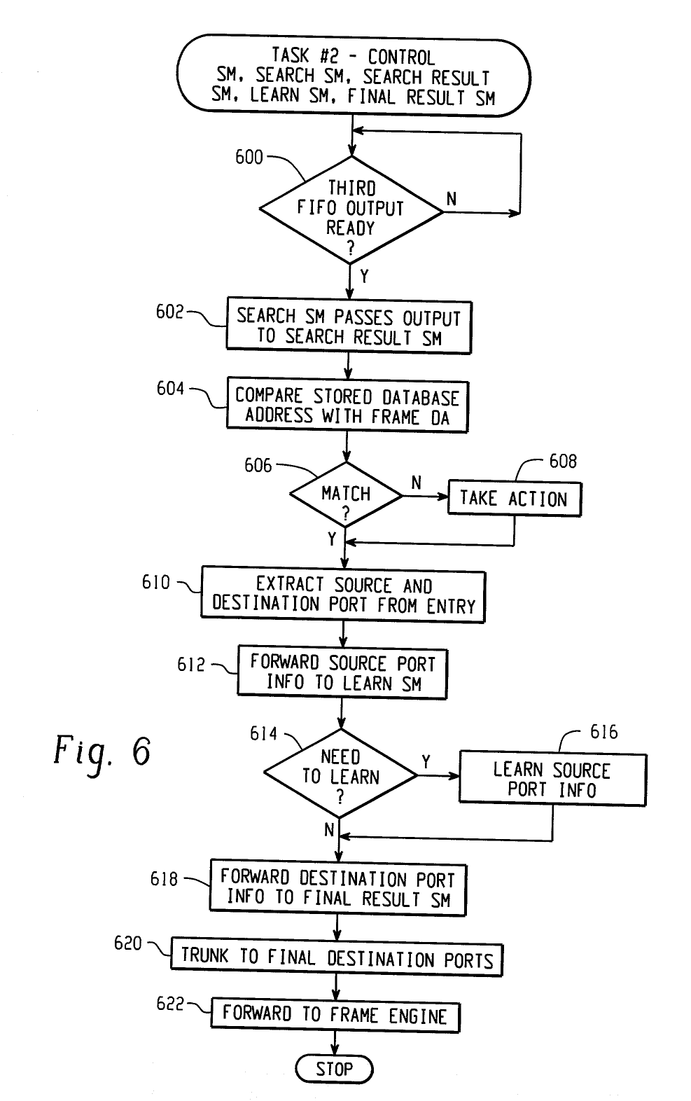

Referring now to FIG. 6, there is illustrated a flow chart of a second task, in accordance with a disclosed embodiment. Flow begins at a starting point and continues to a decision block 600 where the output port of the third FIFO 122 is monitored for availability of an entry. If no entry is available, flow is out the “N” path, and loops back to the input of decision block 600 to continue monitoring for an available entry. On the other hand, if an entry becomes available, flow is out the “Y” path to a function block 602 where the Search SM 124 retrieves and passes the available entry to the Search Results SM 130. The Search Result SM 130 then takes the stored MAC/IP address of the database entry and compares it with the DA 210 of the packet 208 which is from the second FIFO 116 output. Flow is then to a decision block 606 to determine if a match has occurred. If not, flow is out the “N” path to a function block 608 where some action is taken in response to the mismatched information. This action could ultimately include flooding all ports with the packet, except the source port, in order to provide some level of assuredness that the packet would reach its desired destination. Flow is then from function block 608 to the “Y” output of decision block 606 where if a match has occurred, flow is out the “Y” path of decision block 606 to a function block 610 to extract the source and destination port information from the entries. Flow is to a function block 612 where the source port information is then forwarded to the Learn SM 142. Flow is to a decision block 614 to determine if learning is required. If so, flow is out the “Y” path to a function block 616 to complete the learning process. Flow is from function block 616 to the “N” output of decision block 614, where if learning is not required, flow is out the “N” path of decision block 614 to a function block 618 where the destination port information is then forwarded to the Final Result SM 144. The Final Result SM 144 then trunks (or regroups) the port information in to the final destination ports, as indicated in a function block 620. Flow is then to a function block 622 where the final information is then forwarded to a Frame Engine 112 for ultimate forwarding to the appropriate destination ports. As mentioned hereinabove, if learning is required, the search engine 100 could take longer than eleven clock cycles to complete the learning process.

Referring now to FIG. 7, there is illustrated a diagram of a data structure 700 for an external MAC address. In this particular embodiment, the database 118 is a 32-bit wide address structure utilizing the MAC address data structure. For each MAC address, 64 bits are required to form an entry. The MAC address structure comprises the following: an 11-bit link pointer 702 (Bit[63:53]); a 3-bit status word 704 (Bit[52:50]); a 4-bit destination port word 706 (Bit[49:46]); a 45-bit MAC address 708 (Bit[45:1]); and a 1-bit timestamp 710 (Bit[0]).

Referring now to FIG. 8, there is illustrated a diagram of a data structure 800 for an external IP Multicast address. In this particular embodiment, the database 118 is a 32-bit wide address structure utilizing an external IP Multicast address data structure. For each IP address, 64 bits are required to form an entry. The external IP address structure comprises the following: an 11-bit link pointer 802 (Bit[63:53]); a 3-bit status word 804 (Bit[52:50]); an 8-bit destination port map 806 (Bit[49:42]); and forty-two bits of IP address and VLAN ID 808 (Bit[41:0]).

Referring now to FIG. 9, there is illustrated a diagram of a generic data format of an Ethernet packet 900 with VLAN ID (VLIDx)and VLAN Tag (VLTAGx) information. Other than the DA field (D_MACx) 210 (or field 222 of the tagged VLAN packet 220), the SA field (S_MACx) 212 (or field 224 of the tagged VLAN packet 220) and VLAN fields (of the tagged VLAN packet 220), the following other fields are utilized: header length/version (Hlen_Vers—one byte), Service Type (one byte), Packet length (two bytes), Identification (two bytes), Fragment Offset Flags (two bytes), TTL (one byte), Protocol (one byte), Header Checksum (two bytes), Source IP address (S_IPx—four bytes), Destination IP address (D_IPx—four bytes), and other information bytes which are not shown.

Note that the disclosed search engine architecture is not restricted to network devices, but can be utilized in other types of applications where the search time budget is so constrained.

Although the preferred embodiment has been described in detail, it should be understood that various changes, substitutions and alterations can be made therein without departing from the spirit and scope of the invention as defined by the appended claims.

What is claimed is:

1. A pipeline search engine method, comprising the steps of:
inputting packet information of a packet into an input pipeline structure to obtain intermediate packet information;
processing said intermediate packet information with an intermediate pipeline structure to obtain destination information of a destination output; and
forwarding said destination information to an output pipeline structure for transmission therefrom such that said packet is routed to said destination output.

2. The method of claim 1, wherein said packet information in the step of inputting comprises header information of said packet which is parsed by a header parser of said input pipeline structure to generate parsed packet information.

3. The method of claim 2, wherein said parsed packet information comprises both a source device address and a destination address of said destination output which are hashed to yield a database entry pointer of said database.

4. The method of claim 1, wherein said packet in the inputting step which is associated with said packet information that is processed through the pipeline search engine, is transmitted at or substantially near wire speed.

5. The method of claim 1, wherein said packet information in the inputting step is processed through the pipeline search engine in less than eleven clock cycles.

6. The method of claim 1, wherein said input pipeline structure in the inputting step includes a header parser which parses, processes, and classifies said packet information.

7. The method of claim 1, wherein said packet in the inputting step is a tagged VLAN Ethernet packet.

8. The method of claim 1, wherein said packet in the inputting step is an untagged VLAN Ethernet packet.

9. The method of claim 1, wherein said packet in the inputting step is an Ethernet packet.

10. The method of claim 1, wherein said packet in the inputting step is a unicast packet.

11. The method of claim 1, wherein said packet in the inputting step is a multicast packet which is forwarded to a plurality of said destination outputs in accordance with said packet information.

12. The method of claim 1, wherein said input pipeline structure in the inputting step is operable to receive a plurality of said packet information of respective said packets via eight input ports operating in accordance with a Gigabit-Ethernet.

13. The method of claim 1, wherein said packet information in the inputting step is processed through the pipeline search engine in less than eleven clock cycles.

14. The method of claim 1, wherein the pipeline search engine comprises a control state machine which controls operation of the pipeline search engine such that if said packet information of the inputting step is associated with said destination information which is new to the pipeline search engine, said control state machine causes the pipeline search engine to learn the association of said packet information with said new destination information.

15. The method of claim 1, wherein said intermediate pipeline structure of the processing step comprises a control state machine which monitors an output of said first pipeline structure, said control state machine initiates a search state machine for searching a database of said second pipeline structure in accordance with said intermediate information to obtain said destination information.

16. The method of claim 15, wherein if said destination information which corresponds to said intermediate information of the inputting step is not in said database, said control state machine initiates a learning step utilizing a learning state machine of said output pipeline structure of the forwarding step, said learning state machine causing said database to be updated to include new destination information associated with said intermediate information.

17. The method of claim 1, wherein said destination information comprises a MAC/IP address and the corresponding destination port ID.

18. The method of claim 1, wherein said destination information is trunked in said output pipeline structure of the forwarding step.

19. A pipeline search engine, comprising:
an input pipeline structure receiving packet information of a packet thereinto to obtain intermediate packet information;
an intermediate pipeline structure for processing said intermediate packet information to obtain destination information of a destination output; and
an output pipeline structure for processing said destination information therethrough such that said packet to routed to said destination output.

20. The engine of claim 19, wherein said packet information comprises header information of said packet which is parsed by a header parser of said input pipeline structure to generate parsed packet information.

21. The engine of claim 20, wherein said parsed packet information comprises both a source device address and a destination address of said destination output which are hashed to yield a database entry pointer of said database.

22. The engine of claim 19, wherein said packet associated with said packet information which is processed through the pipeline search engine, is transmitted at or substantially near wire speed.

23. The engine of claim 19, wherein said packet information is processed through the pipeline search engine in less than eleven clock cycles.

24. The engine of claim 19, wherein said input pipeline structure contains a header parser which parses, processes, and classifies said packet information.

25. The engine of claim 19, wherein said packet is a tagged VLAN Ethernet packet.

26. The engine of claim 19, wherein said packet is an untagged VLAN Ethernet packet.

27. The engine of claim 19, wherein said packet is an Ethernet packet.

28. The engine of claim 19, wherein said packet is a unicast packet.

29. The engine of claim 19, wherein said packet is a multicast packet which is forwarded to a plurality of said destination outputs in accordance with said packet information.

30. The engine of claim 19, wherein said input pipeline structure is operable to receive a plurality of said packet information of respective said packets via eight input ports operating in accordance with a Gigabit-Ethernet.

31. The engine of claim 19, wherein said packet information is processed through the pipeline search engine in less than eleven clock cycles.

32. The engine of claim 19, wherein the pipeline search engine comprises a control state machine which controls operation of the pipeline search engine such that if said packet information is associated with said destination information which is new to the pipeline search engine, said control state machine causes the pipeline search engine to learn the association of said packet information with said new destination information.

33. The engine of claim 19, wherein said intermediate pipeline structure comprises a control state machine which monitors an output of said first pipeline structure, said control state machine initiates a search state machine for searching a database of said second pipeline structure in accordance with said intermediate information to obtain said destination information.

34. The engine of claim 33, wherein if said destination information which corresponds to said intermediate information is not in said database, said control state machine initiates a learning step utilizing a learning state machine of said output pipeline structure, said learning state machine causing said database to be updated to include new destination information associated with said intermediate information.

35. The engine of claim 19, wherein said destination information comprises a MAC/IP address and the corresponding destination port ID.

36. The engine of claim 19, wherein said destination information is trunked in said output pipeline structure.

37. A pipeline search engine, comprising:
a plurality of logically partitioned pipeline structures operable for;
inputting packet information of a packet into a first pipeline of said plurality of pipeline structures to generate pointing information therefrom,
processing said pointing information with a second pipeline structure of said plurality of pipeline structures to obtain destination information of one or more destination outputs, and
forwarding said destination information to an output pipeline structure of said plurality of pipeline structures for transmission of said packet to said one or more destination outputs.

38. The engine of claim 37, wherein the pipeline search engine comprises a control state machine which controls operation of the pipeline search engine such that if said packet information is associated with said destination information which is new to the pipeline search engine, said control state machine causes the pipeline search engine to learn the association of said packet information with said new destination information.

39. The engine of claim 37, wherein said packet associated with said packet information which is processed through the pipeline search engine, is transmitted at or substantially near wire speed.

40. The engine of claim 37, wherein said packet information is processed through the pipeline search engine in less than eleven clock cycles.
